(19) United States
(12) Patent Application Publication
(10) Pub. No.: US 2007/0165243 A1
(43) Pub. Date: Jul. 19, 2007

(54) Device for measuring 3d shape using irregular pattern and method for the same

(76) Inventors: Cheol-Gwon Kang, Gyeonggi-do (KR); Paul Kim, Anaheim, CA (US)

Correspondence Address: SHERIDAN ROSS PC, 1560 BROADWAY, SUITE 1200, DENVER, CO, 80202, US

(21) Appl. No.: 10/597,773

(22) PCT Filed: Jan. 11, 2005
(86) PCT No.: PCT/KR05/00076

§ 371 Date: Aug. 7, 2006

(30) Foreign Application Priority Data
Feb. 9, 2004 (KR) 10-2004-0008272
Nov. 1, 2004 (KR) 10-2004-0087986

(51) Int. Cl. G01B 11/24; G01B 11/30; G06K 9/00

(52) U.S. Cl. 356/603; 382/154

(57) ABSTRACT

The present invention relates to a device and method for measuring a three-dimensional shape and, more particularly, to a measurement device and method in which a specific pattern is generated on the surface of an object to be measured, the object is photographed using a camera, and data on the 3-D shape are acquired from a photographed image, wherein an irregular pattern is employed, thus simplifying a process of measuring the 3-D shape. The present invention is suitable for the measurement of a moving object, the fabrication of the device can be easily performed, various pattern generation means can be utilized, and an inexpensive and popularized image camera can be used instead of an expensive industrial camera. The present invention can be applied to the fabrication of custom-made shoe soles and custom-made shoes and a medical field.

### TECHNICAL FIELD

The present invention relates to a device and method for measuring a three-dimensional shape and, more particularly to a measurement device and method in which a specific pattern is generated on the surface of an object to be measured, the object is photographed using a camera, and data on the 3-D shape are acquired from a photographed image, wherein an irregular pattern is employed, thus simplifying a process of measuring the 3-D shape.

### BACKGROUND ART

A three-dimensional (3-D) measurement device in which one or more cameras and a projector attached fixedly or detachably to the cameras are combined with each other was proposed as an example of prior art technology for measuring the shape of a 3-D object.

FIG. 1 is a drawing showing an example of the prior art 3-D measurement device (Korean Unexamined Pat. Publication No. 2001-0009721), and the measurement process thereof is as follows:

(1) Camera Calibration

Prior to photographing an object to be measured using a Charge Coupled Device (CCD) camera set, the relative positions (external variables), focal distances and lens distortion coefficients (internal variables) of cameras are obtained from a reference coordinate system.

(2) Camera Synchronization

If an object is photographed using a first camera and then photographed again using a second camera, excessive time is required. Accordingly, the cameras are synchronized with each other to simultaneously receive images using the two cameras.

(3) Stripe Pattern Projection

To search for the correspondence of a specific line of an image photographed by the first camera to a line of an image photographed by the second camera, a series of patterns is projected onto the object to be measured and the patterns are repeatedly photographed by the cameras.

(4) 3-D Point Data Implementation

A computer control unit obtains 3-D point data using pattern image information. For this purpose, a single line having the same history is selected from among the lines corresponding to a final pattern reflected by each photographed image, and the 3-D coordinates of the points constituting the line are obtained.

In such prior technology, different patterns 114 (for example, gray code, a spatially encoded pattern and a moire fringe) each composed of regular stripes are projected by a projector 113 onto the object to be measured, the images of the object are received by cameras 111 and 112 whenever each of the patterns 114 is projected, and a number of images corresponding to the number of patterns (usually, more than 10) are used in the calculation of the 3-D measurement.

However, the prior art technology is disadvantageous in that a number of photographing operations corresponding to the number of patterns is required for one 3-D shape measurement, so that the time required for the measurement ranges from one second to several tens of seconds, thus not being suitable for objects (for example, a human foot) that constantly moves. Furthermore, the prior art technology is disadvantageous in that equipment for the prior art technology is expensive and an industrial camera must be employed for high-speed photographing, so that the prior art technology is uneconomical.

### DISCLOSURE OF INVENTION

Technical Problem

In order to solve the above-described problem, an object of the present invention is to provide a measurement device and method in which a specific pattern is generated on the surface of an object to be measured, the object is photographed using a camera, and data on the 3-D shape are acquired from a photographed image, wherein an irregular pattern included in the image is employed as a criterion for searching for correspondence with respect to the data on the 3-D shape, thus simplifying a process of measuring the 3-D shape.

Another object of the present invention is to provide a 3-D shape measurement method that is capable of implementing the above-described 3-D shape measurement device.

Technical Solution

In order to achieve the above-described objects, the present invention provides a device for measuring a 3-D shape using an irregular pattern, including an irregular pattern generation means for generating an irregular pattern on a surface of an object to be measured; a photographing means for acquiring an image of the object on which the irregular pattern is generated; a control unit for controlling the photographing means; and an operation unit for generating data on the 3-D shape by processing the image of the object acquired by the photographing means; wherein the irregular pattern included in the image is employed as a criterion for searching for correspondence with respect to the data on the 3-D shape while the photographed image of the object is processed into the data on the 3-D shape.

Preferably, the irregular pattern generation means is a projector, and the photographing means is at least one camera.

Preferably, the irregular pattern generation means is a cloth, preferably, a sock, on which an irregular pattern is formed and which comes into contact with the surface of the object, and the photographing means is at least two cameras.

Preferably, the irregular pattern is a pattern in which an irregular portion is formed on a regular pattern. More preferably, the irregular pattern is a pattern in which an irregular stripe is inserted between regularly arranged stripes.

Preferably, correspondence is searched for in such a way that, when the photographed image is represented using a gray value, portions in which the gray value abruptly changes are recognized as edges, an edge at which the gray value irregularly changes due to the irregular portion is regarded as a reference edge, and unique identifications are assigned to the edges.

In addition, the present invention provides a method of measuring a 3-D shape using an irregular pattern, including the steps of generating an irregular pattern on a surface of an object to be measured in a form in which at least one irregular portion is formed on a regular pattern; acquiring an image of the object, on which the irregular pattern is generated, using photographing means; and processing the image of the object into data on the 3-D shape using the irregular pattern, which is included in the image, as a criterion for searching for correspondence with respect to the data on the 3-D shape.

Advantageous Effects

In accordance with the present invention, an irregular pattern is employed, so that a 3-D shape can be measured by a single image acquisition operation, like a general camera and unlike a prior art 3-D shape measurement device and method that requires excessive measurement time, thus being suitable for the measurement of a moving object, and a single irregular pattern is employed, so that the fabrication of the device can be easily performed, various pattern generation means can be utilized and an inexpensive and popularized image camera or web camera can be used instead of an expensive industrial camera, thus being economical.

As for applications, the present invention can be applied to the manufacture of shoe soles in such a way as to measure the soles of feet using the device of the present invention and perform a CNC operation based on 3-D data, and can be applied to the manufacture of shoes in such a way as to measure entire feet using the present invention. Using 3-D data on human feet, the present invention can be applied in a medical field for persons having abnormal feet (for example, for walking analysis).

### BRIEF DESCRIPTION OF THE DRAWINGS

FIG. 1 is a drawing showing an example of a prior art 3-D measurement device;

FIG. 2 is a view showing irregular patterns according to an embodiment of the present invention;

FIG. 3 is a diagram showing a 3-D measurement device using two cameras and one projector and an object onto which an irregular pattern is projected;

FIG. 4 is a diagram showing a 3-D measurement device using one camera and one projector and an object onto which an irregular pattern is projected;

FIG. 5 is a diagram showing two cameras, a cloth on which an irregular pattern is printed, and an object that is surrounded by the cloth;

FIG. 6 is a diagram showing correspondent points shown in images and 3-D linear vectors connected to the correspondent points;

FIG. 7 is a diagram showing correspondent lines shown in images photographed by two cameras;

FIG. 8 is a view illustrating a process of calculating the coordinates of a 3-D line using one camera and one projector;

FIGS. 9 to 11 are views showing a process of obtaining correspondent points from an irregular pattern;

FIG. 12 is a photograph showing that a foot in a sock into which an irregular pattern is woven is photographed by two cameras;

FIG. 13 is a photograph showing images photographed by the two cameras through the process of FIG. 12; and

FIG. 14 is a photograph representing a 3-D shape photographed through the process of FIG. 12 in the form of 3-D polygon data.

### BEST MODE FOR CARRYING OUT THE INVENTION

Preferred embodiments of the present invention is described in detail with reference to the accompanying drawings.

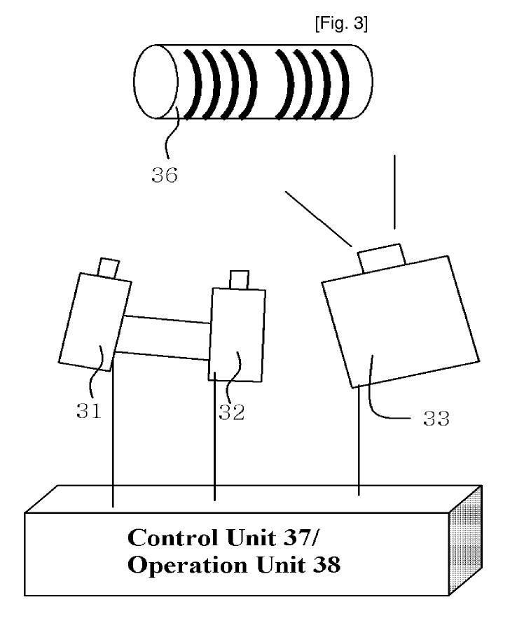

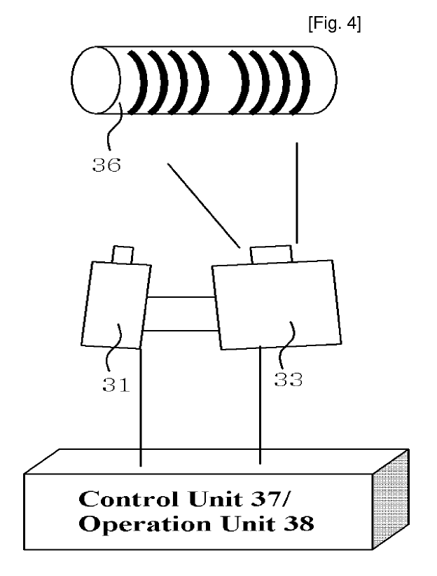

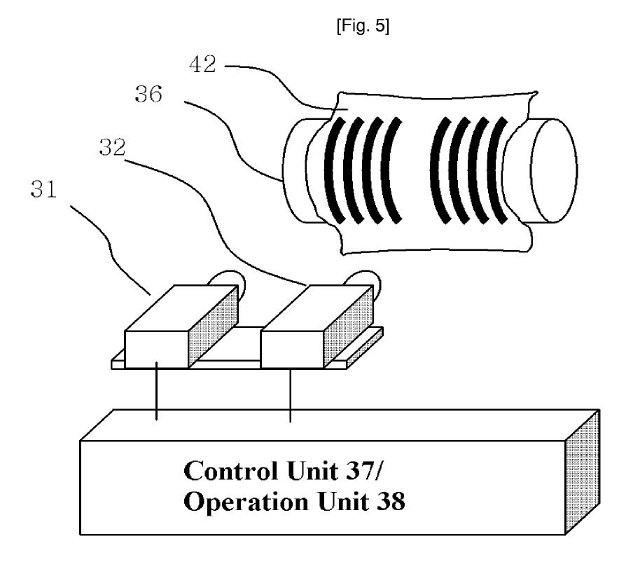

FIG. 2 is a view showing irregular patterns according to an embodiment of the present invention, FIG. 3 is a diagram showing a 3-D measurement device using two cameras and one projector and an object onto which an irregular pattern is projected, FIG. 4 is a diagram showing a 3-D measurement device using one cameras and one projector and an object onto which an irregular pattern is projected, and FIG. 5 is a diagram showing two cameras, a cloth on which an irregular pattern is printed, and an object that is surrounded by the cloth.

A 3-D measurement device according to the present invention includes an irregular pattern generation means for generating irregular patterns, a photographing means for acquiring images of an object to be measured on which the irregular patterns are generated, a control unit for controlling the photographing means, and an operation unit for generating 3-D shape data by processing the images acquired by the photographing means. The control unit and the operation unit are implemented using, for example, typical computers (desktop computers or notebook computers). They are preferably implemented using a single computer.

First, the irregular pattern generation means is described below.

The irregular patterns exemplified in FIG. 2 are composed of stripes that do not have the same line interval (that is, that have at least one different interval), or circles, doughnuts, rectangles or other shapes that do not have the same size.

The irregular pattern generation means is exemplified by a projector 33 for projecting irregular patterns or a cloth 42 on which an irregular pattern is printed.

A Liquid Crystal Display (LCD) projector, a Digital Light Processing (DLP) projector, a slide projector, a laser projector or the like may be employed as the projector 33.

Taking the case in which an LCD projector is employed as an example, when the LCD projector is pointed at an object 36 and the image of an irregular pattern is displayed on a computer monitor, the irregular pattern is projected from the LCD projector connected to a computer and is generated on the surface of the object. In the case in which the slide projector is employed, a film on which an irregular pattern is printed is loaded into the slide projector and the irregular pattern is projected from the slide projector.

For example, a cloth that is formed by printing black stripes on a white cloth, as described in FIG. 5, is employed as the cloth 42 on which the irregular pattern is printed. The generation of the irregular pattern can be achieved by surrounding an object with the cloth. In the case in which the object to be measured is a foot, a sock on which an irregular pattern is printed or into which an irregular pattern is woven may be employed as the cloth 42.

Next, the photographing means is described below.

The photographing means is a means for acquiring the image of the object 36 in which an irregular pattern is generated. A camera is employed as the photographing means. For example, a Charge Coupled Device (CCD) camera, a Complementary Metal Oxide Semiconductor (CMOS) camera, an image camera, a web camera or a digital camera may be employed as the photographing means.

The camera may be composed of one or two cameras 31 and 32, as exemplified in FIGS. 3, 4 and 5, and acquires the images of the object in which irregular patterns are generated by the irregular pattern generation means 33 and 42.

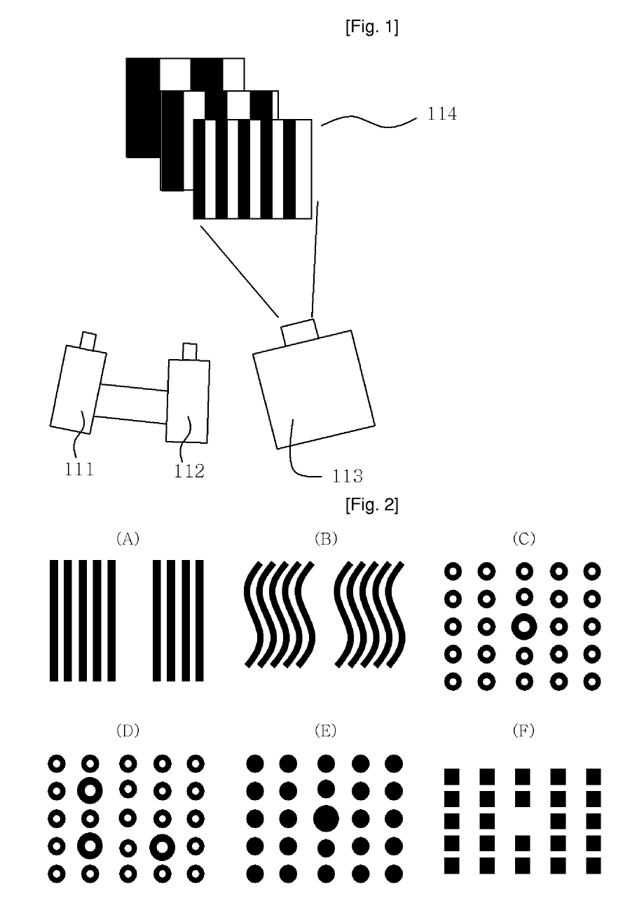

In the prior art technology exemplified in FIG. 1, the number of patterns 114 projected onto an object to be measured is two or more (usually, more than ten) to search for correspondence, so that a plurality of images are acquired. Unlike the prior art technology, in the present embodiment, each camera acquires one image at a time by photographing an object on which an irregular pattern is generated. Accordingly, in the case in which the number of cameras is one, a single image is acquired, and in the case in which the number of cameras is two, two image are acquired.

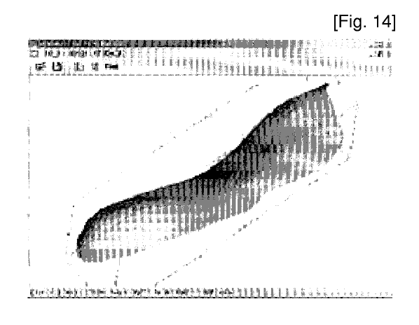

Although, in the examples of FIGS. 12 and 13, two cameras are horizontally located and photographs are then taken, the two cameras may be rotated (for example, may be counterclockwise rotated by 90° or clockwise rotated by 90°) and used in that position so that a user can conveniently photograph the object. In this case, the object on which the irregular pattern is generated (for example, a foot in a sock into which an irregular pattern is woven) needs to be rotated in the same direction.

*Next, the control unit is described below.

A desktop computer, a notebook computer, a microcomputer or a device having the same function may be employed as the control unit.

The control unit 37 performs control so that the photographing means can acquire the image of the object to be measured when the irregular pattern is generated on the object to be measured, and functions to transfer the acquired image to the operation unit. Preferably, in the case in which the irregular pattern generation means is the projector, the control unit 37 functions to transmit an irregular pattern displayed on the screen of a monitor to the projector that is connected to the control unit 37.

Next, the operation unit is described below.

A desktop computer, a notebook computer, a microcomputer or a device having the same function may be employed as the operation unit 38. Preferably, the operation unit 38 may be integrated with the control unit 18. The operation unit 38 functions to generate 3-D data by processing one or two images acquired through the photographing means.

A process of measuring a 3-D shape using two cameras in accordance with an embodiment of the present invention.

(1) Camera Calibration

Prior to photographing the object 36 to be measured using the two cameras 31 and 32, the relative positions (external variables), focal distances and lens distortion coefficients (internal variables) of the cameras 31 and 32 are determined using a reference coordinate system.

(2) Generation and Photographing of Irregular Pattern

To search for the correspondence of a specific line of an image photographed by the first camera 31 to a line of an image photographed by the second camera 32, irregular patterns are projected onto the object 36 to be measured and images are acquired by photographing the patterns using the cameras 31 and 32.

FIGS. 9 to 11 are views illustrating a process of obtaining correspondent points from an irregular pattern.

The most important thing in 3-D shape measurement is to search for correspondent points or correspondent lines in the measurement process.

Meanwhile, in the case in which only stripes having the same interval exist in a 3-D space, as shown in FIG. 7, it is difficult to find correspondent lines (sets of correspondent points) that form pairs.

To precisely measure a 3-D shape, it is necessary to form a large number of stripes (in the case of photographing the sole of a foot; more than 30). For example, in the case where 29 stripes are photographed by the first camera 31 and 25 stripes are photographed by the second camera 32, it is difficult to set a reference line. That is, the case in which a first line photographed by the first camera 31 is different from a first line photographed by the second camera 32 may occur.

*Accordingly, to find such correspondent lines, the prior art technology employs a method of sequentially projecting a series of patterns (gray code, a spatially encoded pattern and a moire fringe; ten or more patterns) onto an object to be measured using a projector, repeatedly photographing the object, and assigning histories to lines or points included in photographed images.

*In contrast, the present invention generates an irregular pattern on the surface of an object, photographs the object using cameras, and searches for correspondent lines or correspondent points using the irregular pattern included in the photographed image.

FIG. 9 shows the case in which an irregular pattern, in which white stripes and black stripes constitute a pattern and one interval between black stripes is wider and the remaining intervals between black stripes are the same, is employed.

Numerals 1 to 16 designate the identifications (IDs) of edges (edges are the boundaries between the white stripes and the black stripes). In the direction from the left side to the right side, the up edges from which the black color changes to the white color are designated by odd numerals, and the down edges from which the white color changes to the black color are designated by even numerals.

With reference to FIG. 10, a method of searching for edges is described below.

An ideal white color is assigned a gray value of 255, and an ideal black color is assigned a gray value of 0.

When the gray values of the stripes are found along the direction from the left side of an actually photographed image to the right side, the white and black stripes of FIG. 9 are represented by gray values between 0 to 255, as shown in FIG. 10, which are represented by a number of sine curves corresponding to the number of stripes.

In such curves, the points at which their slope abruptly changes or has a value of 0 designate edges. While such two types of edges may be taken into account, only the points at which the slope abruptly changes are regarded as edges in the present invention.

When an irregular pattern composed of such stripes (or bands) is included in an image photographed by a camera, a white line (a wide white portion between ID 1 and ID 10) that causes the interval between a black stripe and a neighboring black stripe to be widest is searched for along the direction from the left side of the image to the right side. The white stripe becomes a reference line. The wider the width of such a white line, the clearer the difference between the interval of such a white line and the other intervals, thus allowing such a white line to be easily found. In the cases of FIGS. 12 and 13, the reference line has a width approximately four or five times that of the other white lines.

At a first step, the ID of the left edge of the widest white line is set to 1, and the ID of the entire edge is set to 0 while the entire edge is traced in a vertical direction.

After the ID setting for the first edge has been completed, IDs are sequentially set for new edges along the left direction until an eighth line is found.

At a next step, the process returns to the widest white line (reference line), and IDs are sequentially set for the remaining lines along the right direction while up edges (odd numerals) are distinguished from down edges (even numerals). Through this process, IDs can be set for all the lines, so that correspondent lines can be found.

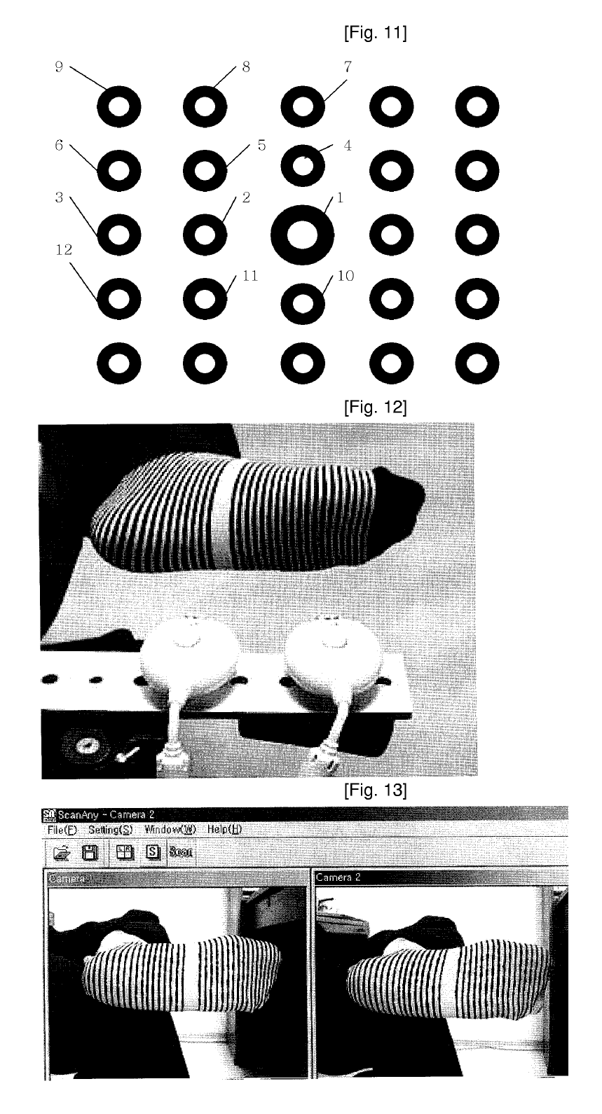

FIG. 11 illustrates the case in which an irregular pattern in which one doughnut has a larger size is employed. Numerals 1 to 12 are some of the IDs of all the doughnuts.

At a first step, a doughnut having the largest size is searched for, an ID of 1 is set for the doughnut, and IDs of 2 and 3 are set for doughnuts in the left direction. At a next step, IDs of 4, 5 and 6 are set for doughnuts that are located above the first doughnut in the left direction.

After the processing in the upward direction and the processing in the left direction have been completed as described above, processing in the downward direction and processing in the left direction are performed. When ID setting for the right part is performed symmetrically to the ID setting for the left part after the ID setting for the left part, IDs are set for all the doughnuts, so that correspondent points can be found.

In the meantime, another method for setting IDs for doughnuts is taken as an example below. That is, a method of searching for a central doughnut having the largest size, setting ID 1 for the central doughnut, setting IDs for eight neighboring doughnuts and setting IDs for doughnuts adjacent to the eight doughnuts may be employed.

After the above-described process has been completed, the correspondence in which the line (point) of the image of the first camera corresponding to ID 1 is the same as the line of the image of the second camera corresponding to ID 1 can be found.

(3) Implementation of 3-D Point Data

The implementation of 3-D point data is performed by the operation unit using correspondent points or correspondent lines included in the images photographed by the two cameras.

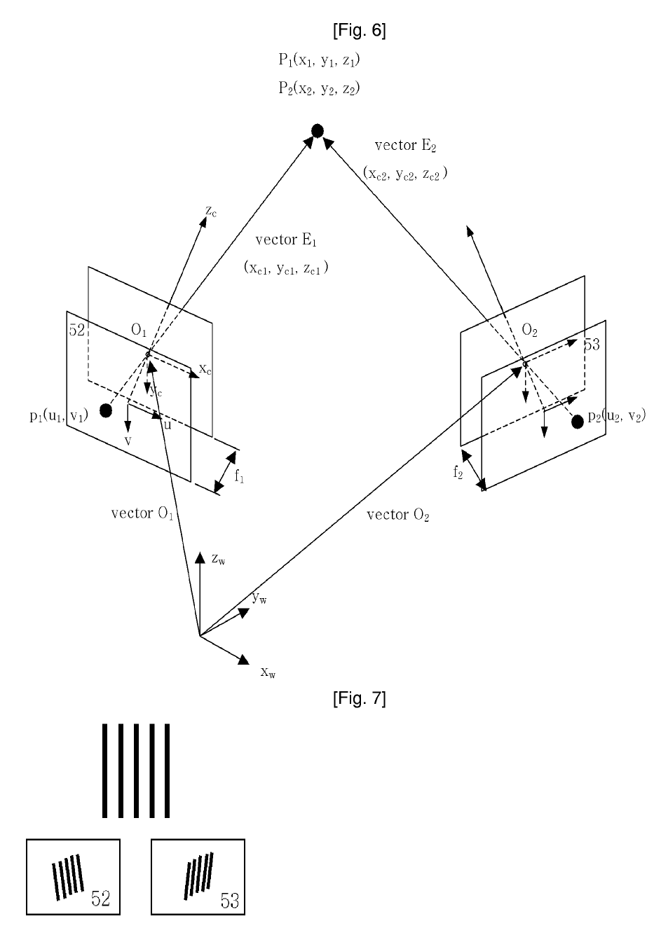

In the case in which the irregular pattern is composed of points, a correspondent point p₁(u₁, v₁) or p₂(u₂, v₂) of FIG. 6 is directly searched for through the step (2). In the case in which the irregular pattern is composed of lines, a point on a correspondent line found through the step (2) is searched for as the correspondent point p₁(u₁, v₁) or p₂(u₂, v₂).

FIG. 6 is a view illustrating correspondent points p₁(u₁, v₁) and p₂(u₂, v₂) shown in images and 3-D linear vectors connected to the correspondent points. With respect to 3-D points P₁(x₁, y₁, z₁) and P₂(x₂, y₂, z ₂) existing on the surface of an object to be measured, two points p₁(u₁, v₁) and p₂(u₂, v₂)shown in the images 52 and 53, respectively, photographed by the two cameras and the linear vectors of a camera coordinate system, that is, vector E₁ and vector E₂, are illustrated in the drawing. In this case, the images 52 and 53 photographed by the cameras may be images that are detected by CMOSs or CCDs that are the image detection means of the cameras.

The illustrated coordinate system formed by coordinate axes x_{w}, y_{w}, z_{w} refers to a world coordinate system, and another coordinate system x_{c}, y_{c}, z_{c} refers to a camera coordinate system.

The two points p₁(u₁, v₁) and p₂(u₂, v₂) shown in the images 52 and 53, respectively, photographed by the cameras are correspondent points, which form a pair.

In consideration of the point p₁(u₁, v₁) shown in the image 52 photographed by the first camera, its linear vector E₁(x_{c1}, y_{c1}, z_{c1}), the focal distance f₁ of the first camera, and the parameter t₁ of the vector, the following correlation Equations are established.
vector E₁=(x_{c1}, Y_{c1}, Z_{c1})=(t₁u₁, t₁v₁, t₁f₁)
vector P₁=(x₁, y₁, z₁)=vector O₁+vector E₁

When a linear vector E1 is obtained with respect to the correspondent point p₂(u₂, v₂) of the image 53 photographed by the second camera in the same manner and the intersecting point of the two linear vectors E₁ and E₂ is obtained, the intersecting point is the coordinates of the point P₁ or P₂. The above description is expressed by Equations as follows:
vector E₂=(x_{c2}, y_{c2}, z_{c2})=(t₂u₂, t₂v₂, t₂f₂)
vector P₂=(x₂, y₂, z₂)=vector O₂+vector E₂
vector P₁=vector P₂
(x₁, y₁, z₁)=(x₂, y₂, z₂)

Since, in the above-described Equations, f₁, f₂, vector O₁ and vector O₂ can be obtained through the camera calibration step, the number of unknowns (t₁ and t₂) is two and the number of Equations (x₁=x₂, y₁=y₂, z₁=z₂) is three, so that the coordinates x₁, y₁, z₁ of P₁ (or coordinates x₂, y₂, z₂ of P₂) can be obtained through matrix calculation (for example, least squares solution).

Meanwhile, in the case in which a cloth, a sock or a projector in which a relative coordinate system with respect to the cameras is not fixed is employed as the irregular pattern generation means, at least two cameras are necessary to generate 3-D shape data in the above-described manner.

A process of measuring a 3-D shape using a single camera in accordance with another embodiment of the present invention is described below.

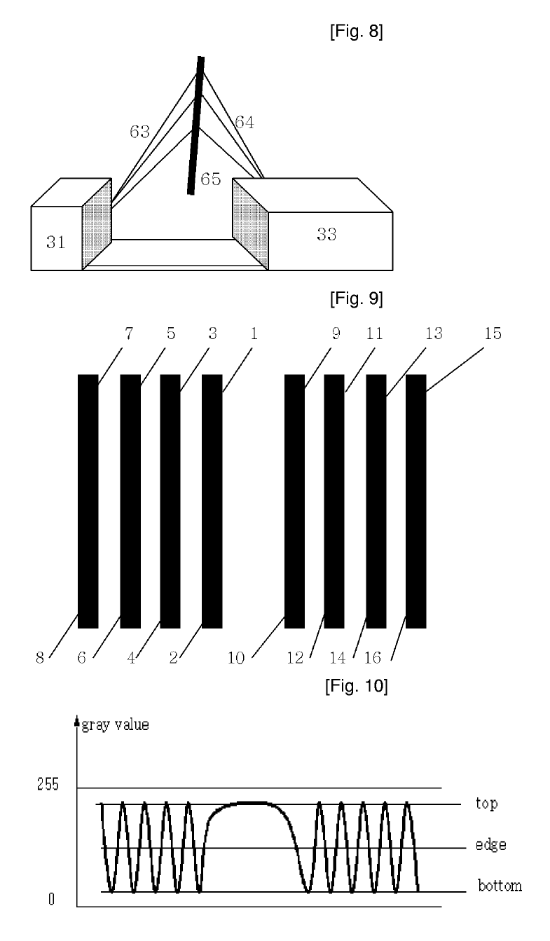

FIG. 8 is a diagram illustrating a process of measuring the coordinates of a 3-D line using a single camera and a single projector. In the present embodiment, the single camera and the single projector are employed.

A single stripe 65 is projected from a projector 33 into a space, and a camera 31 photographs the stripe 65. In a manner similar to that of the case in which two cameras are employed, a linear vector 64 projected from the projector 33 is obtained and a linear vector 63 is obtained from an image that is photographed by the camera 31 and reflects the stripe 65, and the intersecting point between the two linear vectors 63 and 64 is obtained.

In more detail, the equation of the boundary line (edge line; 65) of the stripe projected from the projector 33 is obtained based on a 3-D reference coordinate system, the 3-D coordinates of the lamp point of the projector 33 are obtained, and the 3-D plane equation of a plane formed by the edge line and the lamp point is obtained.

The plane equation is obtained at the camera calibration step, and is the unique value of a 3-D measurement device. For example, when the IDs of edge lines formed in stripe shapes are set to 1 to 30, respectively, 30 plane equations are obtained.

Thereafter, the coordinates of a 3-D point can be obtained by locating an object to be measured in front of a measurement device, performing projection using the projector 33, searching for a plane equation (plane equation stored at the camera calibration step) corresponding to the edge line 65 projected onto the surface of the object, and acquiring the intersecting point of the plane equation and the imaginary linear vector 63 extending from the camera 31.

For example, a scheme, in which, when the ID of an edge line (a set of edge points) is 12, a plane equation corresponding to the edge line having an ID of 12 is searched for from a camera calibration file previously stored at the camera calibration step, and the intersecting point of the plane equation and an imaginary linear vector extending from a camera image (edge point having an ID of 12) is acquired, is used.

FIG. 12 is a photograph showing that a foot in a sock into which an irregular pattern is woven is photographed by two cameras, and FIG. 13 is a photograph showing images photographed by the two cameras through the process of FIG. 12.

The images were acquired using a sock into which stripes were woven as the irregular pattern generation means and two image cameras as the photographing means. A desktop computer was used as the control unit and the operation unit.

FIG. 14 is a photograph representing a 3-D shape photographed through the process of FIG. 12 in the form of 3-D polygon data.

The 3-D shape is displayed on the screen of a computer in such a way as to search the two images, which are acquired by the photographing means, for correspondent lines (sets of correspondent points), calculate the lines (sets of points) of the 3-D shape, and process the 3-D data into polygons.

The above-described invention can be implemented in various forms without departing from the technical spirit or principal features of the invention. Accordingly, it should be appreciated that the above-described embodiments are illusrative and are not restrictive.

1. A device for measuring a three-dimensional (3-D) shape using an irregular pattern, comprising:
irregular pattern generation means for generating an irregular pattern on a surface of an object to be measured;
photographing means for acquiring an image of the object on which the irregular pattern is generated;
a control unit for controlling the photographing means; and
an operation unit for generating data on the 3-D shape by processing the image of the object acquired by the photographing means;
wherein the irregular pattern included in the image is employed as a criterion for searching for correspondence with respect to the data on the 3-D shape while the photographed image of the object is processed into the data on the 3-D shape.

2. The device as set forth in claim 1, wherein the irregular pattern generation means is a projector, and the photographing means is at least one camera.

3. The device as set forth in claim 1, wherein the irregular pattern generation means is a cloth on which an irregular pattern is formed and that comes into contact with the surface of the object, and the photographing means is at least two cameras.

4. The device as set forth in claim 3, wherein the irregular pattern generation means is a sock.

5. The device as set forth in claim 1, wherein the irregular pattern is a pattern in which an irregular portion is formed on a regular pattern.

6. The device as set forth in claim 5, wherein the irregular pattern is a pattern in which an irregular stripe is inserted between regularly arranged stripes.

7. The device as set forth in claim 5, wherein correspondence is searched for in such a way that, when the photographed image is represented using a gray value, portions in which the gray value abruptly changes are recognized as edges, an edge at which the gray value irregularly changes due to the irregular portion is regarded as a reference edge, and unique identifications are assigned to the edges.

8. A method of measuring a 3-D shape using an irregular pattern, comprising the steps of:
generating an irregular pattern on a surface of an object to be measured in a form in which at least one irregular portion is formed on a regular pattern; acquiring an image of the object, on which the irregular pattern is generated, using photographing means; and
processing the image of the object into data on the 3-D shape using the irregular pattern, which is included in the image, as a criterion for searching for correspondence with respect to the data on the 3-D shape.

9. The method as set forth in claim 8, wherein correspondence is searched for in such a way that, when the photographed image is represented using a gray value, portions in which the gray value abruptly changes are recognized as edges, an edge at which the gray value irregularly changes due to the irregular portion is regarded as a reference edge, and unique identifications are assigned to the edges.

10. The device as set forth in claim 2, wherein the irregular pattern is a pattern in which an irregular portion is formed on a regular pattern.

11. The device as set forth in claim 3, wherein the irregular pattern is a pattern in which an irregular portion is formed on a regular pattern.

12. The device as set forth in claim 4, wherein the irregular pattern is a pattern in which an irregular portion is formed on a regular pattern.
